(19) United States
(12) Patent Application Publication
(10) Pub. No.: US 2023/0138300 A1
(43) Pub. Date: May 4, 2023

(54) Lens Assembly

(71) Applicants: Dae Soon LIM, Yongin-si, Gyeonggi-do (KR); MICRO ACTUATOR CO., LTD., Yongin-si, Gyeonggi-do (KR)

(72) Inventors: Dae Soon LIM, Yongin-si (KR); Hak Ku YOON, Suwon-si (KR); Myung Won CHOI, Yongin-si (KR); Dong Sung LEE, Pyeongtaek-si (KR)

(21) Appl. No.: 17/910,685

(22) PCT Filed: Sep. 18, 2020
(86) PCT No.: PCT/KR2020/012593

§ 371 Date: Sep. 9, 2022

(30) Foreign Application Priority Data
May 6, 2020 (KR) 10-2020-0053768

(51) Int. Cl. H04N 23/68; H04N 23/67; H04N 23/55; H04N 23/54

(52) U.S. Cl. CPC H04N 23/687; H04N 23/675; H04N 23/55; H04N 23/54

(57) ABSTRACT

A lens assembly applied to a small mobile device is disclosed. The lens assembly comprises: a base; a lens module disposed inside the base; first and second image stabilization driving units for moving the lens module in the direction perpendicular to the optical axis direction; and a plurality of hinge members which movably support the lens module and are disposed to be parallel to each other, wherein the plurality of hinge members have column parts that gradually protrude toward the center thereof and are injection-molded with a synthetic resin material.

### TECHNICAL FIELD

The disclosure relates to a lens assembly, and more particularly to an ultra-small lens assembly having an auto focus function and an optical image stabilization (OIS) function.

### BACKGROUND ART

Lens assemblies which are applied to small mobile devices such as smartphones are becoming miniaturized according to developments in technology, and have an auto focus function and an optical image stabilization (OIS) function to obtain captured images of high quality.

The auto focus function may be a function which moves a lens module provided in the lens assembly forward or backward to automatically match a focal point to a specific subject.

The OIS function may be a function which detects a shaking of a mobile device (e.g., a smartphone, a tablet personal computer (PC), etc.) with a gyro sensor and corrects the focal point by minutely moving the lens module in an opposite direction of a direction to which the mobile device moves. A movement of the lens module when performing OIS may be carried out in a direction perpendicular to a direction to which a lens moves when performing auto focusing. The lens assembly may support the lens module with a plurality of metal wires having elasticity so that the lens module may move smoothly when performing OIS.

Recently, small mobile devices are being applied with image sensors having 108 megapixels to realize high quality images, and lens sizes applied accordingly have also increased. For example, while lenses which were previously applied have a diameter of about less than or equal to 9.1φ, lenses used together with high-definition image sensors have a diameter of greater than or equal to 15φ. As described above, a weight of the lens may also increase as the size of the lens increases.

Accordingly, small mobile devices have a disadvantage of an amount of electricity consumed increasing to drive a more heavier lens module according to employing the high-definition image sensor. Based on the above, there is an inconvenient disadvantage of having to charge a battery embedded in the small mobile device more often as a camera function is used more.

In addition, as the weight of the lens increases, there is a disadvantage of a lens focal point not being accurately maintained as the lens module is tilted because the metal wire of a fine thickness is unable to withstand the weight of the lens module and a center portion of the metal wire is bent. Further, there is a disadvantage of the camera function of the small mobile device not being performed due to being vulnerable to force such as the metal wire breaking and the like when the small mobile device is subject to an external force or dropped on a floor.

However, if the metal wires are formed more thickly than the existing metal wires to solve the disadvantages described above, more power is to be applied to a driving part for OIS for a normal operation because a movement width of the lens module becomes smaller compared to when existing wires of a fine thickness are used when performing OIS. The above leads to a disadvantage of power consumption of a charging battery of a small mobile device accelerating.

### DISCLOSURE

### Technical Problem

An object of the disclosure is in providing a lens assembly configured such that a plurality of hinge members supporting a lens module to be movable is formed to be strong against external force and to not be bent due to a weight of a lens for optical image stabilization (OIS).

Another object of the disclosure is in providing a lens assembly which can minimize power being consumed by a driving part for adjusting auto focus and OIS.

### Technical Solution

To achieve the objects described above, the present disclosure provides a lens assembly including a base, a lens module disposed at an inner side of the base, driving parts for a first optical image stabilization (OIS) and a second OIS configured to move the lens module in a perpendicular direction of an optical axis direction, and a plurality of hinge members configured to support the lens module to be movable and disposed parallel to one another, and the plurality of hinge members is characterized in that a column part is gradually protruded to be convex as it nears a center and is injected molded with a synthetic resin.

The lens assembly may further include a support inserted in the base to be movable in the optical axis direction, and a driving part for adjusting auto focus which moves the support in the optical axis direction, and each of the plurality of hinge members may be configured so that one end part is fixed to four corners of the support, and other end part is fixed to the lens module.

An adhesive may be applied to a portion through which the one end part of the plurality of hinge members and the support are connected to one another, and an adhesive may be applied to a portion through which the other end part of the plurality of hinge members and the lens module are engaged to one another.

Each of the plurality of hinge members may be configured such that a first connection part is formed in-between the one end part and the column part and a second connection part is formed in-between the other end part and the column part, and each of the first and second connection parts is formed to a thickness thinner than a thickness of the column part.

The driving part for adjusting auto focus may be a piezo actuator, and the piezo actuator may include a piezoelectric device fixed to the base, and an expandable bar configured such that one end is connected to one side of the piezoelectric device and is connected to the support.

The support may further include a guide bar guiding a movement of the support in the optical axis direction by being connected to a corner which faces the corner at which the expandable bar is connected in a diagonal direction to be slidable.

Each of the plurality of hinge members may be configured such that one end part is fixed to four corners of the base, and other end part is fixed to the lens module.

An adhesive may be applied to a portion through which the one end part of the plurality of hinge members and the base are connected to one another, and an adhesive may be applied to a portion through which the one end part of the plurality of hinge members and the lens module are engaged with one another.

The lens assembly may further include a movable member which moves an image sensor disposed at a rear direction of the lens module in the optical axis direction, and a driving part for adjusting auto focus for the movable member to move in the optical axis direction.

The movable member may include a first portion to which the image sensor is engaged, and a second portion extended from the first portion and disposed in-between a side wall of the base and the lens module.

The image sensor may be mounted to one portion of a flexible printed circuit board (FPCB), and other portion of the FPCB is disposed in a folded state based on the one portion of the FPCB.

The driving part for adjusting auto focus may include a magnet disposed at the second portion, and a coil disposed at a side wall of the base so as to face the magnet.

### DESCRIPTION OF DRAWINGS

FIG. 1 is an assembled view illustrating a lens assembly according to an embodiment of the disclosure;

FIG. 2 and FIG. 3 are exploded perspective views illustrating a lens assembly according to an embodiment of the disclosure;

FIG. 4 is perspective view illustrating a base of a lens assembly according to an embodiment of the disclosure;

FIG. 5 is a perspective view illustrating a support of a lens assembly according to an embodiment of the disclosure;

FIG. 6 is a plane view illustrating a state in which a support and a lens module of a lens assembly are engaged according to an embodiment of the disclosure;

FIG. 7 is a cross-sectional view taken along line A-A marked in FIG. 6;

FIG. 8 is an enlarged perspective view illustrating a first engagement groove of a lens module to which one end of a hinge member is connected;

FIG. 9 is an enlarged perspective view illustrating a second engagement groove of a support to which other end of a hinge member is connected;

FIG. 10 is a plane view illustrating a state in which an inner cover and an outer cover of a lens assembly is omitted according to an embodiment of the disclosure;

FIG. 11 is a cross-sectional view taken along line B-B marked in FIG. 10;

FIG. 12 is a view of open loop hysteresis curves compared according to whether first and second centering alignment protrusions are present;

FIG. 13 is a schematic view illustrating a lens assembly according to another embodiment of the disclosure; and

FIG. 14 and FIG. 15 are exploded perspective views illustrating a lens assembly according to still another embodiment of the disclosure.

### DETAILED DESCRIPTION OF EXEMPLARY EMBODIMENTS

Various embodiments will be described in greater detail below with reference to the accompanied drawings. Embodiments described herein may be variously modified. A specific embodiment may be illustrated in the drawings and described in detail in the detailed description. However, the specific embodiment described in the accompanied drawing is only to assist in the easy comprehension of the various embodiments. Accordingly, it should be noted that the technical spirit of the disclosure is not limited by the specific embodiments described in the accompanied drawings, and should be interpreted to include all modifications, combinations, equivalents and/or alternatives of the embodiments included in the spirit of the disclosure and in the technical scope

Terms including ordinal numbers such as first and second may be used in describing various elements, but the elements are not limited by the above-described terms. The above-described terms may be used only for the purpose of distinguishing one element from another element.

In addition thereto, in describing the disclosure, in case it is determined that the detailed description of related known functions or configurations may unnecessarily confuse the gist of the disclosure, the detailed description thereof will be omitted.

A lens assembly according to an embodiment of the disclosure may be manufactured to an ultra-small size and installed in a small mobile device such as a smartphone to be used in capturing an image.

The lens assembly according to an embodiment of the disclosure will be described in detail below with reference to the drawings.

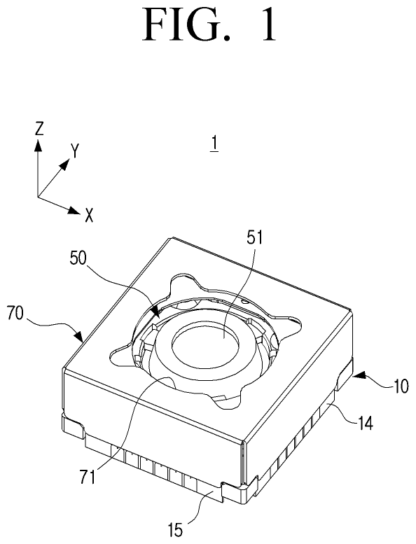

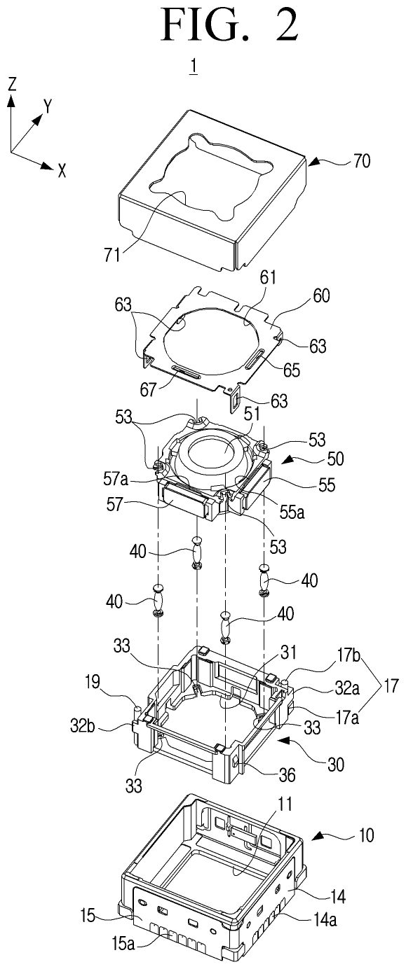

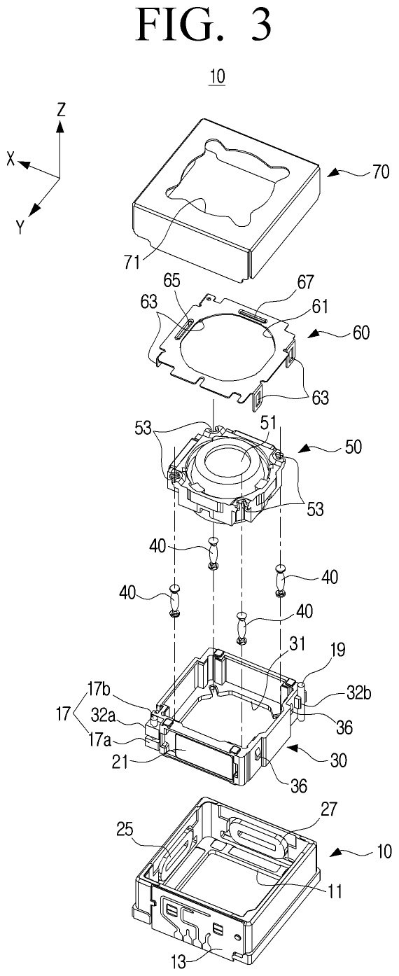

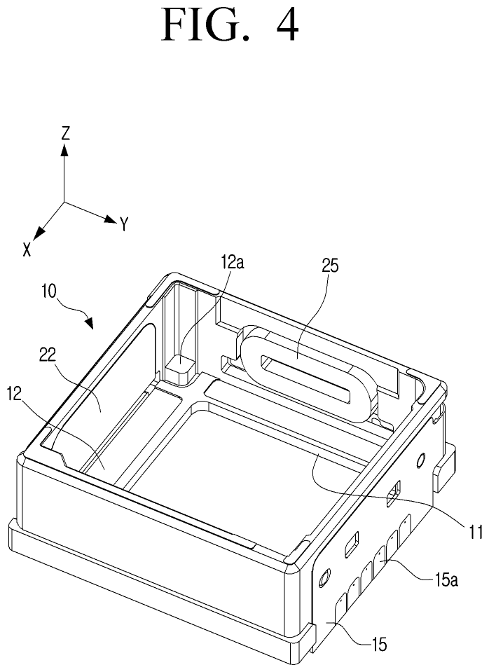

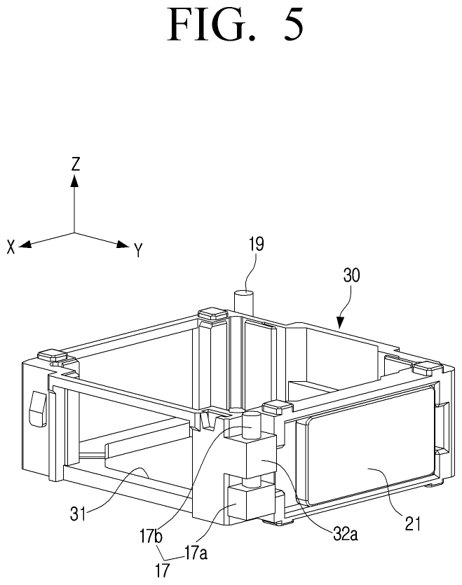

FIG. 1 is an assembled view illustrating the lens assembly according to an embodiment of the disclosure, FIG. 2 and FIG. 3 are exploded perspective views illustrating the lens assembly according to an embodiment of the disclosure, FIG. 4 is perspective view illustrating a base of the lens assembly according to an embodiment of the disclosure, and FIG. 5 is a perspective view illustrating a support of the lens assembly according to an embodiment of the disclosure.

Referring to FIG. 1 to FIG. 3, a lens assembly 1 according to an embodiment of the disclosure may include a base 10, a support 30 which moves a lens module 50 in a Z-axis direction (herein, the Z-axis direction may mean an optical axis direction) for auto focusing, a lens module 50 which is disposed at an inner side of the support 30 and includes a lens part 51 formed of a plurality of lenses, a plurality of hinge members 40 configured such that the lens module 50 connects the support 30 and the lens module 50 for the lens module 50 to be movable along a X-Y plane based on the support 30 for OIS, an inner cover 60 configured to prevent the lens module 50 from separating from the support 30, and an outer cover 70 configured to cover one side of the base 10.

Referring to FIG. 4, the base 10 may be installed at one portion of the small mobile device (not shown), and a printed circuit board (not shown) to which an image sensor (not shown) is mounted may be disposed at a lower side (an opposite side of a side covered by the outer cover 70) of the base 10.

The base 10 may be formed roughly as a cuboid. In addition to the cuboid, the shape of the base 10 may be appropriately changed according to a size and shape of the small mobile device to which a lens assembly 10 is installed.

The base 10 may be provided with a predetermined space in which the support 30 disposed at the inner side moves along the Z-axis direction, and a floor part 12 may be formed with a first light passing hole 11. The light which passed the lens module 50 may be irradiated to the image sensor positioned at the lower side of the base 10 through the first light passing hole 11 formed at the base 10.

The base 10 may have a seat part 12a protruded and formed at one corner from among four corners of the floor part 12. The seat part 12a may be fixed with a piezo actuator 17 which will be described below. Specifically, one surface of a piezoelectric element 17a of the piezo actuator 17 may be fixed.

The piezo actuator 17 may move the support 30 forward or backward in the Z-axis direction. The piezo actuator 17 may be applied with a current through a first printed circuit board 13 disposed at the base 10. The piezo actuator 17 may include a piezoelectric element 17a with a length that is variable in one direction by electric-field according to the current being applied, and an expandable bar 17b with one end engaged at one side of the piezoelectric element 17a. The expandable bar 17b may have a thrust which moves the support 30 forward or backward in the Z-axis direction by expanding in a length direction according to a varied length of the piezoelectric element 17a.

The support 30 may be formed with an engagement part 32a through which the expandable bar 17b is penetrated and inserted to one corner of the support 30 on which the piezo actuator 17 is disposed.

The support 30 may be guided by a guide bar 19 when moving forward or backward along the Z-axis direction by the driving of the piezo actuator 17. The guide bar 19 may be disposed in another corner which is at a diagonally opposite side based on the one corner of the support 30 on which the piezo actuator 17 is disposed. In this case, the guide bar 19 may be engaged to an engagement protrusion 32b which is formed at the support 30 to be slidable.

The support 30 may be guided through a plurality of balls (not shown) rather than the guide bar 19. Specifically, the plurality of balls may be disposed in a state contacting each of the base 10 and the support 30 between an inner side corner of the base 10 and an outer side corner of the support 30 corresponding thereto. In order for the support 30 to smoothly operate by a driving of the piezo actuator 17, an inertial movement of the support 30 may be made possible by the expansion operation of the expandable bar 17b having a constant preload applied to the support 30 at all times.

Referring to FIG. 4 and FIG. 5, the lens assembly may include a preload magnet 21 engaged to one surface of the support 30 and a magnetic material 22 disposed at the base 10 to face the preload magnet 21 at a certain interval. An interacting magnetic force of the preload magnet 21 and the magnetic material 22 may be exerted as a force supporting the support 30 by pulling the support 30 toward the base 10 with a certain force. Accordingly, a preload part may not only assist in a detailed realization of the inertial movement and stop operation of the support 30 when driving the piezo actuator 17, but also eliminate a phenomenon of the support 30 being tilted.

When the current is applied to the piezo actuator 17, the piezoelectric element 17a may be configured such that the length is varied in a direction parallel to the Z-axis direction due to the electric-field and the expandable bar 17b is expanded accordingly. In this case, the support 30 preloaded by a force provided from the preload part may adjust a focal point distance of a lens by performing inertial movement and moving along the Z-axis direction.

Specifically, the forward and backward movements of the support 30 may be carried through the following operation. If a forward direction current is repeatedly applied to the piezoelectric element 17a, the support 30 may move forward because the expandable bar 17b is expanded as the piezoelectric element 17a repeats a stretching operation and a rapid restoration operation due to the electric-field of the forward direction current. Alternatively, if a reverse direction current is repeatedly applied to the piezoelectric element 17a, the support 30 may move backward because the expandable bar 17b is contracted as the piezoelectric element 17a repeats the stretching operation and the rapid restoration operation due to the electric-field of the reverse direction current.

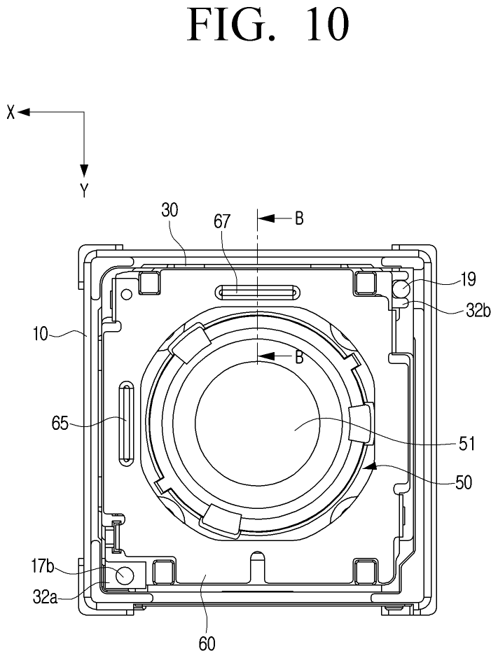

The support 30 may be formed in a rough cuboid shape in a size smaller than the base 10. The support 30 may be disposed to movable forward and backward along the Z-axis direction from the inner side of the base 10 (referring to FIG. 10).

The driving part for OIS will be described with reference to FIG. 2 and FIG. 3.

The lens assembly according to an embodiment of the disclosure may include a driving part for a first OIS for moving the lens module 50 in an X-axis direction, and a driving part for a second OIS for moving the lens module 50 in an Y-axis direction.

The driving part for the first OIS may include a first coil 25 disposed at one side surface from among four side surfaces of the base 10 and a first magnet 55 disposed at one side surface from among the four side surfaces of the lens module 50.

The first magnet 55 may be disposed to face the first coil 25 with a certain interval therebetween based on the lens module 50 being disposed in an inner side space of the base 10 together with the support 30.

The driving part for the first OIS may move the lens module 50 in a +X-axis direction or a −X-axis direction through interaction with the first magnet 55 according to a direction of the current being applied to the first coil 25.

The first coil 25 may be electrically connected to a second printed circuit board 14 installed at the base 10. The first magnet 55 may be disposed at one side surface of the lens module 50. In this case, in-between the first magnet 55 and the lens part 51, a first shielding member 55a of a flat plate shape engaged to the lens module 50 may be disposed. The driving part for the first OIS may not be affected by an electromagnetic field generated from the driving part for the second OIS due to the first shielding member 55a.

The second printed circuit board 14 may be formed with a plurality of terminals 14a to receive power and a control signal from the outside. The second printed circuit board 14 may be mounted with a first hall sensor (not shown). The first hall sensor may be positioned at an inner side of the first coil 25 in a closed curve shape and detect movement of the first magnet 55, and transmit the detected signal to a control part of the small mobile device. The control part may perform control in the X-axis direction of the lens module 50 through the first hall sensor of the second printed circuit board 14 and the driving part for the first OIS.

The driving part for the second OIS may include a second coil 27 disposed at a side surface adjacent to the surface on which the first coil 25 is disposed from among the four side surfaces of the base 10, and a second magnet 57 disposed at a side surface adjacent to the surface on which the first magnet 55 is disposed from among the four side surfaces of the lens module 50.

The second magnet 57 may be disposed to face the second coil 27 with a certain interval therebetween based on the lens module 50 being disposed in the inner side space of the base 10 together with the support 30.

The driving part for second OIS may move the lens module 50 in a +Y-axis direction or a −Y-axis direction through interaction with the second magnet 57 according to the direction of the current being applied to the second coil 27.

The second coil 27 may be electrically connected to a third printed circuit board 15 installed at the base 10. The second magnet 57 may be disposed at one side surface of the lens module 50. In this case, in-between the second magnet 57 and the lens part 51, a second shielding member 57a of a flat plate shape engaged to the lens module 50 may be disposed. The driving part for second OIS may not be affected by the electromagnetic field generated from the driving part for the first OIS due to the second shielding member 57a.

The third printed circuit board 15 may be formed with a plurality of terminals 15a for receiving power and a control signal from the outside. The third printed circuit board 15 may be mounted with a second hall sensor (not shown). The second hall sensor may be positioned at an inner side of the second coil 27 in a closed curve shape and detect movement of the second magnet 57, and transmit the detected signal to the control part of the small mobile device. The control part may perform control in the Y-axis direction of the lens module 50 through the second hall sensor of the third printed circuit board 15 and the driving part for the second OIS.

The driving parts for the first OIS and the second OIS may move the lens module 50 in the X-axis direction and the Y-axis direction and correct the position of the lens part 51 as a result of shaking hands. The lens module 50 may move in the X-axis direction due to the driving part for the first OIS, and move in the Y-axis direction due to the driving part for second OIS. Accordingly, the lens module 50 may be connected to the support 30 to be movable through the plurality of hinge members 40 which will be described below. Accordingly, the lens module 50 may move to any one position on the X-Y plane in a state supported by the support 30.

The support 30 may be formed with a second light passing hole 31. Based on the support 30 being inserted in the inner side space of the base 10, the second light passing hole 31 may correspond to the first light passing hole 11 of the base 10. Light which passed the lens part 51 may sequentially pass the second light passing hole 31 and the first light passing hole 11 and reach of the image sensor (not shown).

The plurality of hinge members 40 which support the lens module 50 to be movable in the X-axis direction and the Y-axis direction based on the support 30 will be described below. The plurality of hinge members 40 may all be formed in a same shape and four hinge members may be provided.

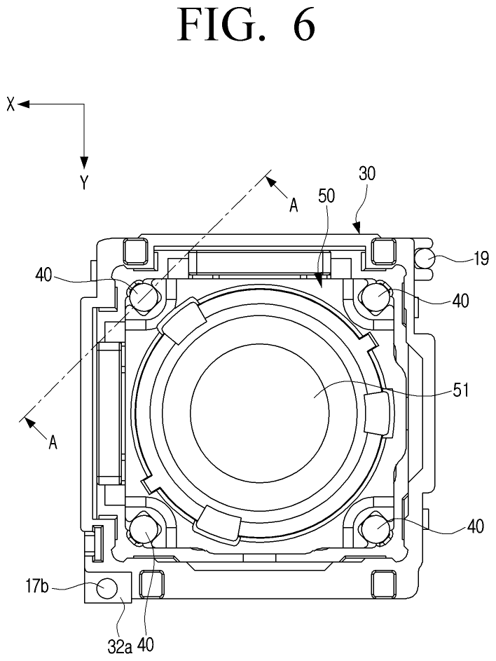

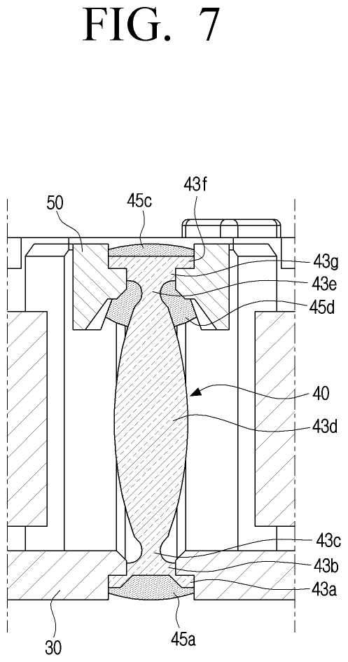

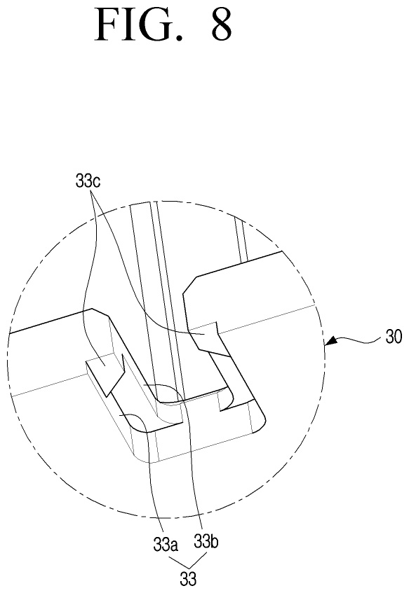

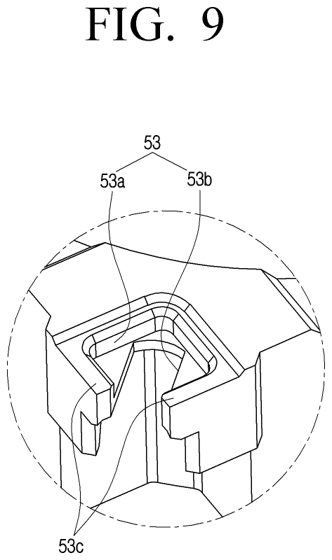

FIG. 6 is a plane view illustrating a state in which the support and the lens module of the lens assembly are engaged according to an embodiment of the disclosure, FIG. 7 is a cross-sectional view taken along line A-A marked in FIG. 6, FIG. 8 is an enlarged perspective view illustrating a first engagement groove of the lens module to which one end of a hinge member is connected, and FIG. 9 is an enlarged perspective view illustrating a second engagement groove of the support to which other end of the hinge member is connected.

The plurality of hinge members 40 may be configured such that each one end part is inserted and fixed in a plurality of first engagement grooves 33 formed at four corners of the inner side of the support 30, and each other end part is inserted and fixed in a plurality of second engagement grooves 53 formed at the four corners of the outer side of the lens module 50.

The plurality of hinge members 40 may be formed of a material having elasticity so that the plurality of hinge members may be restored to its original position when the driving parts for the first OIS and the second OIS are not operated after moving to any one point on the X-Y plane by the driving parts for the first OIS and the second OIS.

Specifically, it may be preferable for the plurality of hinge members 40 to be formed with a synthetic resin material (e.g., thermoplastic elastomer (TPE)) which is a nonconductor and has superior durability.

Because the plurality of hinge members 40 may be formed with a synthetic resin material, the plurality of hinge members may be manufactured by injection molding. Although the lens assembly of the related art, which includes wires with a very fine thickness that are formed of a metal material of the related art, has the disadvantage of wires breaking easily when an external force is applied, the hinge member according to an embodiment may not only have good durability as there is no breakage even with external force applied to the lens assembly 1, but may also enhance a reliability of a product.

A structure of the hinge member 40 interconnecting the support 30 and the lens module 50 will be described in detail below with reference to FIG. 7 to FIG. 9.

The plurality of hinge members 40 may be formed such that the shapes are all the same. Accordingly, the above will be described based on one hinge member.

The hinge member 40 may include a column part 43d having a predetermined length and thickness, a lower end part 43a disposed at a lower end of the column part 43d, an upper end part 43f disposed at an upper end of the column part 43d, a first connection part 43c formed between the column part 43d and the lower end part 43a, and a second connection part 43e formed between the column part 43d and the upper end part 43f.

The lower end part 43a of the hinge member 40 may form a first stepped part 43b positioned between the lower end part 43a and the first connection part 43c. The first stepped part 43b may be formed to have a width narrower than the lower end part 43a. The lower end part 43a of the hinge member 40 may be engaged to a first engagement part 33a of the first engagement groove 33, and the first stepped part 43b may be engaged to a second engagement part 33b of the first engagement groove 33.

The lower end part 43a of the hinge member 40 may not be separated from the first engagement groove 33 due to a pair of first hook protrusions 33c provided in the first engagement groove 33 and maintain an engaged state before applying an adhesive.

A first adhesive 45a is applied to a connecting portion between the support 30 and the hinge member 40 so that the hinge member 40 is fixed firmly to the support 30. Accordingly, when an external force is applied to the lens assembly 1, the hinge member 40 may be fundamentally blocked from being separated from the support 30.

The upper end part 43f of the hinge member 40 may be formed with a second stepped part 43g positioned between the upper end part 43f and the second connection part 43e. The second stepped part 43g may be formed to have a width narrower than an upper end part 43f. The upper end part 43f of the hinge member 40 may be engaged to a first engagement part 53a of the second engagement groove 53, and the second stepped part 43g may be engaged to a second engagement part 53b of the second engagement groove 53.

The upper end part 43f of the hinge member 40 may not be separated from the second engagement groove 53 due to a pair of second hook protrusions 53c provided in the second engagement groove 53 and maintain an engaged state before applying an adhesive.

Second and third adhesives 45c and 45d may be applied to a connecting portion between the lens module 50 and the hinge member 40 so that the hinge member 40 may be firmly fixed to the lens module 50. Accordingly, when an external force is applied to the lens assembly 1, the hinge member 40 may be fundamentally blocked from being separated from the support 30. After the first adhesive 45a is hardened by sequentially permeating in-between the lower end part 43a and the first engagement part 33a of the first engagement groove and in-between the first stepped part 43b and the second engagement part 33b of the first engagement groove, the connecting portion between the support 30 and the hinge member 40 may be firmly fixed.

After the second adhesive 45c is hardened by sequentially permeating in-between an upper end part 43f and a first engagement part 53a of the second engagement groove and in-between the second stepped part 43g and the second engagement part 33b of the first engagement groove, the connecting portion between the support 30 and the hinge member 40 may be firmly fixed. The second adhesive 45c may have a same viscosity as with the first adhesive 45a.

The third adhesive 45d may be applied to encase the second connection part 43e at a lower part of the second engagement groove 53. The third adhesive 45d may be a damping bond, and may be maintained roughly in a gel state even after hardening is completed after application.

The first adhesive 45a may fix the support 30 and the hinge member 40, and the second adhesive 45c may perform the role of fixing the lens module 50 and the hinge member 40. Based on the third adhesive 45d being applied to encase the second connection part 43e, the second connection part 43e may be elastically bent at a predetermined angle so that movement by the lens module 50 on the X-Y plane is possible. Accordingly, the third adhesive 45d may perform the role of a damper which absorbs external force applied to the lens assembly or force generated in a control process.

The hinge member 40 may be adhesively fixed to the support 30 after being first adhesively fixed to the lens module 50. In this case, the second and third adhesives 45c and 45d may be applied to each connecting portion of the hinge member 40 and the lens module 50 in a state in which the upper end part 43f of the hinge member 40 is inserted in the second engagement groove 53. Then, the first adhesive 45a may be applied to the connecting portion of the hinge member 40 and the support 30 in a state in which the lower end part 43a of the hinge member 40 is inserted in the first engagement groove 33.

Alternatively, based on the hinge member 40 being fixed to the lens module 50 after first being adhesively fixed to the support 30, the first and third adhesives 45a and 45d may be applied to each connecting portion of the hinge member and the support 30 in a state in which the lower end part 43a of the hinge member 40 is inserted in the first engagement groove 33. At this time, the third adhesive 45d may be applied to encase the first connection part 43c so as to not interfere with the first connection part 43c being bent, and perform the role of the damper which is capable of absorbing the external force applied to the lens assembly 1. Then, the second adhesive 45c may be applied to the connecting portion of the hinge member 40 and the lens module 50 in a state in which the upper end part 43f of the hinge member 40 is inserted in the second engagement groove 53.

In the embodiment, although both ends of the hinge member 40 have been described as each being fixed by the adhesive to the support 30 and the lens module 50 as an example, it may also be possible for both ends to be engaged in a pressed state without the adhesive.

The first and second connection parts 43c and 43e may be formed thinner than the column part 43d. Accordingly in-between the lower end part 43a and the column part 43d, and in-between the upper end part 43f and the column part 43d may be bent at a predetermined angle. As described above, when the driving parts for the first OIS and the second OIS are operated, the lens module 50 may move smoothly to a X-axis and a Y-axis according to the first and second connection parts 43c and 43e being bent. In addition, the first and second connection parts 43c and 43e may be stored to its original shape by elastic force based on power to the driving parts for the first OIS and the second OIS being blocked.

The column part 43d may be formed in a shape with a center portion that is convex overall according to having a shape which gradually increases in thickness as it nears the center from each of the upper end and the lower end of the column part. In this case, a longitudinal section of the column part 43d may be roughly an elliptical shape, and a cross section may be roughly a circular shape.

Meanwhile, size of lens which is applied to the small mobile device is being increased for high resolution capturing. Accordingly, when the size of the lens is increased, the weight of the lens is also increased. Because the wire hinge of metal material used in the related art is bent by its own malleability in case the weight of the lens module 50 is heavy, controlling the position of the lens module 50 has been difficult. However, in the embodiment, because the column part 43d uses the hinge member 40 which is in the convex shape, a rigidity of the hinge member 40 may be greatly enhanced, and the hinge member 40 may not be bent even if the weight of the lens module 50 is increased.

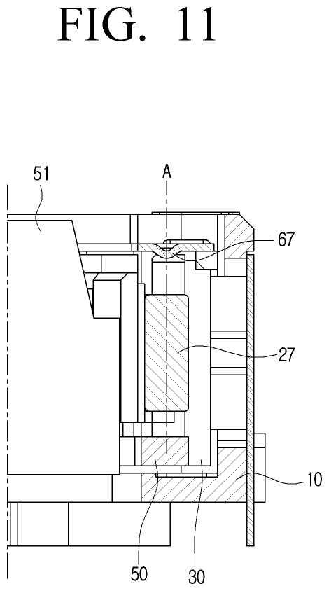

A structure of an inner cover 60 will be described in detail below with reference to FIG. 10 and FIG. 11.

The inner cover 60 may prevent the lens module 50 inserted in the support 30 from separating from the support 30. The inner cover 60 may be formed with a third light passing hole 61 through which an upper part of the lens part 51 may be exposed.

The inner cover 60 may be detachably engaged to the support 30 to cover a portion of an opening of the support 30 for inserting the lens module 50 inside the support 30. In this case, the inner cover 60 may be formed with a plurality of engagement parts 63 which is snap engaged to a plurality of engagement protrusions 36 formed at an outer side surface of the support 30.

According to the inner cover 60 is seated around the opening of the support 30, because there is a predetermined interval with an upper surface of the lens module 50, the lens module 50 is not contacted when moving in the X-axis and Y-axis directions.

The inner cover 60 may include first and second centering alignment protrusions 65 and 67 which are disposed spaced apart to form an angle perpendicular with each other. The first and second centering alignment protrusions 65 and 67 may perform a role of aligning the lens module 50 to a center position when the driving parts for the first OIS and the second OIS are not in operation.

The first centering alignment protrusion 65 may be formed with an embossing so as to protrude toward the first magnet 55. In this case, the first centering alignment protrusion 65 may be disposed at a position corresponding to the first magnet 55 according to a disposition direction of the first magnet 55, and may be formed to a length which is the same or shorter than the length of the first magnet 55.

The second centering alignment protrusion 67 may be disposed in a roughly perpendicular direction based on the first centering alignment protrusion 65, may be formed with embossing to protrude toward the second magnet 57. In this case, the second centering alignment protrusion 67 may be disposed at a position corresponding to the second magnet 57 along the disposition direction of the second magnet 57, and may be formed to a length which is the same or shorter than the length of the second magnet 57.

Based on the inner cover 60 being formed of the magnetic material, a gravitational force may be in action at all times in-between the inner cover 60 and the first and second magnets 55 and 57. The first centering alignment protrusion 65 may be protruded and formed more closely to the first magnet 55 than an interval between the one surface (surface facing the lens module 50) of the inner cover 60 and the first magnet 55. Like the first centering alignment protrusion 65, the second centering alignment protrusion 67 may be protruded and formed more closely to the second magnet 57 than an interval between the one surface (surface facing the lens module 50) of the inner cover 60 and the second magnet 57.

Accordingly, based on the first and second magnets 55 and 57 fixed to the lens module 50 when the driving parts for first OIS and second OIS are not in operation being moved to a position corresponding to the respectively corresponding first and second centering alignment protrusions 65 and 67, the lens module 50 may be naturally aligned to a centering position.

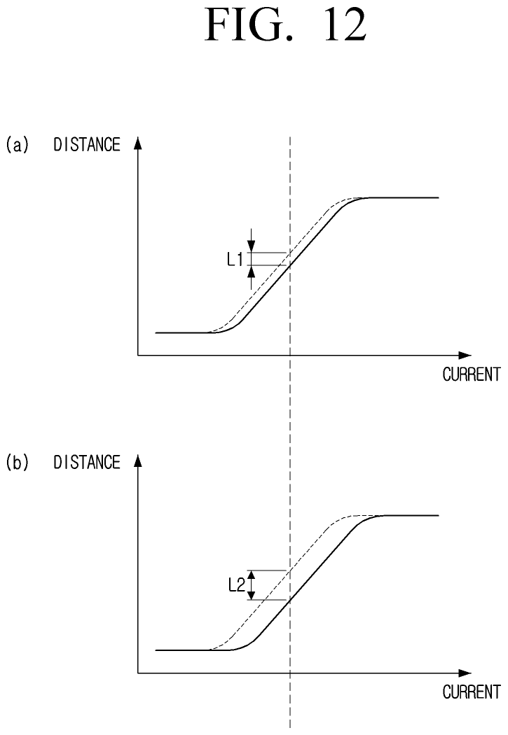

The above may be verified through an open loop hysteresis curve shown in FIG. 12. A distance value L1 corresponding to a certain current value of when (a) there are first and second centering alignment protrusions 65 and 67 may be shown significantly smaller than a distance value L2 of when (b) there are no first and second centering alignment protrusions 65 and 67. Accordingly, in the embodiment in which the first and second centering alignment protrusions 65 and 67 are formed in the inner cover 60, it is shown that the centering of the lens module 50 may be easier.

The lens assembly 1 according to an embodiment as described above may form the first and second centering alignment protrusions 65 and 67 of a simple shape through a simple embossing processing to the inner cover 60 without having a complicated separate centering structure for the centering of the lens module 50. Accordingly, not only is precise controlling of the lens module 50 of a product is made easy, but reliability in the product may also be enhanced.

The outer cover 70 may be engaged to the base 10, and cover the inner cover 60. The outer cover 70 may also be formed with a fourth light passing hole 71 through which the upper part of the lens part 51 may be exposed. The outer cover 70 may be formed with a metal material capable of shielding electromagnetic waves.

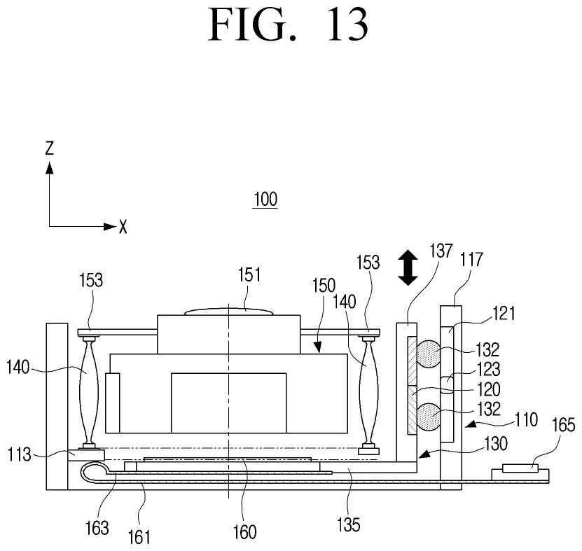

A lens assembly according to another embodiment of the disclosure will be described below with reference to FIG. 13. FIG. 13 is a schematic view illustrating the lens assembly according to another embodiment of the disclosure.

A lens assembly 100 according to another embodiment of the disclosure may include a base 110, a movable member 130, a lens module 150 provided with a lens part 151, and a plurality of hinge members 140 which support the lens module 150 to be movable along the X-Y plane based on the base 110.

Because the plurality of hinge members 140 has the same structure as with the plurality of hinge members 40 provided in the lens assembly 1 according to an embodiment of the disclosure, the detailed description will be omitted.

The plurality of hinge members 140 may be configured such that each one end part is fixed to inner four corners 113 of the base 110, and each other end part is fixed to outer four corners 153 of the lens module 150. In this case, the plurality of hinge members 140 may be configured such that both end parts are firmly fixed to the base 110 and the lens module 150 through an adhesive.

The lens assembly 100 according to another embodiment of the disclosure may be configured such that the lens module 150 is not moved forward or backward along the Z-axis direction (optical axis direction) for adjusting auto focus. The auto focus may be adjusted by an operation in which an image sensor 160 is moved forward to be adjacent to the lens module 150 based on the Z-axis direction or moved backward to be farther from the lens module 150.

Based on realizing auto focus adjustment through a method of the image sensor 160 moving forward or backward, because the image sensor 160 which is lighter in weight than the lens is moved, an amount of power being consumed accordingly may be decreased.

The image sensor 160 may be disposed at a lower side of the lens module 150, and engaged to a first portion 135 of the movable member 130 to move forward or backward in the Z-axis direction by the movable member 130. The image sensor 160 may be inserted in an engagement hole formed at the first portion 135.

A back surface of the image sensor 160 may be mounted to a one portion 163 of a flexible printed circuit board (FPCB). A other portion 161 of the FPCB may be configured such that an end part is moved out to an outer side of the base 110 in a state folded by 180 degrees based on the one portion 163. In this case, the end part of the other portion 161 of the FPCB may be disposed with a connector 165. The connector 165 may be connected with a separate connector (not shown) which is connected to a distal end of an external power wiring or a signal wiring.

Accordingly, because the FPCB is easily deformed when the movable member 130 to which the image sensor 160 is engaged is moved in the Z-axis direction, it does not interfere in the movement of the movable member 130.

The movable member 130 may include a second portion 137 which is extended and formed at the first portion 135, and disposed in-between a side wall 117 of the base 110 and one side of the lens module 150 moving forward or backward in the Z-axis direction.

In-between the second portion 137 and the side wall 117 of the base 110, a plurality of balls 132 may be disposed. The plurality of balls 132 may perform a guide role for the movable member 130 to move forward or backward along the Z-axis direction based on the base 110. The second portion 137 and the side wall 117 of the base 110 may be formed with a V-shape groove (not shown) through which the plurality of balls 132 is guided.

The driving part for adjusting the auto focus to move the movable member 130 may include a magnet 120 which is engaged to the second portion 137 and coil 121 which is disposed at the side wall 117 of the base 100 to face the magnet 120. The coil 121 may be mounted to the printed circuit board (not shown) installed at the base 110.

The driving part for adjusting the auto focus may move the movable member 130 in a Z-axis direction or a −Z-axis direction through interaction with the magnet 120 according to a direction (one direction or reverse direction thereof) of the current applied to the coil 121.

On the printed circuit board on which the coil 121 is disposed, a plurality of terminals for receiving power and a control signal from the outside may be formed, and a hall sensor 123 for detecting a position of the movable member 130 and controlling may be mounted.

The hall sensor 123 may detect a movement of the magnet 120 by being disposed to be surrounded by coil 121 formed in a closed curve, and transmit the detected signal to a control part (not shown) of a small electronic device. The control part may perform control in the Z-axis direction of the support through the hall sensor 123 and the driving part for adjusting the auto focus.

The lens assembly 100 according to another embodiment of the disclosure may include a driving part for a first OIS (not shown) which moves the lens module 150 in the X-axis direction and a driving part for a second OIS (not shown) which moves the lens module 150 in the Y-axis direction for OIS.

The driving parts for the first OIS and the second OIS provided in the lens assembly 100 according to another embodiment of the disclosure may be formed of the same structure as with the driving parts for the first OIS and the second OIS provided in the lens assembly 1 according to an embodiment of the disclosure described above.

For example, the coils of the driving parts for the first OIS and the second OIS may be each disposed at two side surfaces adjacent to the base 110, and the magnets of the driving parts for the first OIS and the second OIS may be each disposed at two side surfaces of the lens module 150 to correspond to each coil.

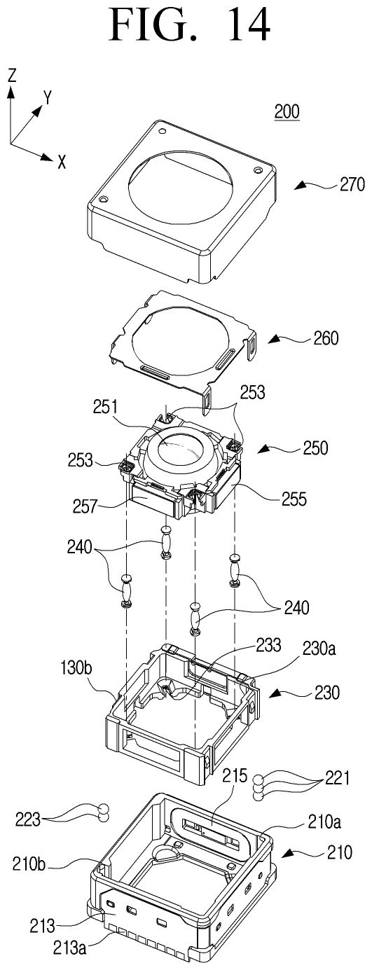

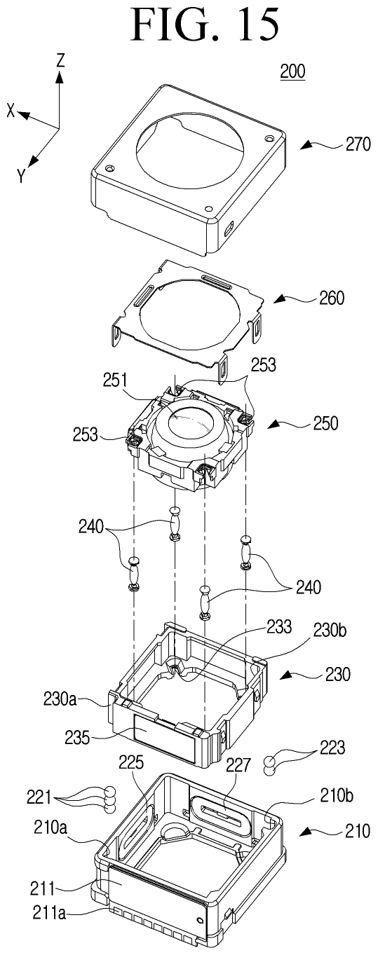

FIG. 14 and FIG. 15 are exploded perspective views illustrating a lens assembly according to still another embodiment of the disclosure.

A lens assembly 200 may be the same in most configurations and different in a part of the configurations with the lens assembly 10 described above. Accordingly, in describing the configuration of the lens assembly 200, the configurations different from the above described lens assembly 10 will be mainly described.

Referring to FIG. 14 and FIG. 15, the lens assembly 200 may include a base 210, a support 230 which moves a lens module 250 in the Z-axis direction (in the disclosure, the Z-axis direction may mean an optical axis direction) for auto focusing, a lens module 250 which is disposed at an inner side of the support 230 and includes a lens part 251 configured of a plurality of lenses, a plurality of hinge members 240 configured such that the lens module 250 connects the support 230 and the lens module 250 for the lens module 250 to be movable along the X-Y plane based on the support 230 for OIS, an inner cover 260 configured to prevent the lens module 250 from separating from the support 230, and an outer cover 270 which covers one side of the base 210.

Each hinge member 240 may be configured such that one end part is engaged to a first engagement groove 233 of the support 230, and other end part is engaged to a second engagement groove 253 of the lens module 250. In this case, the one end part of each hinge member 240 and the first engagement groove 233 may be adhered and fixed by an adhesive, and the other end part of the hinge member 240 and the second engagement groove 253 may be adhered and fixed by the adhesive. Specifically, a damper bond may be used at a connection part of the hinge member.

The lens assembly 200 may include a driving part for adjusting auto focus which is configured of coils 215 and magnets 235 rather than a piezo actuator to adjust auto focus. The coil 215 may be disposed on one surface at an inner side of the base 210, and the magnet 235 may be disposed on one surface at an outer side of the support 230 to correspond to the coil 215 with a certain interval therebetween.

The support 230 may move forward or backward along the Z-axis direction by the driving part for adjusting auto focus. At this time, the support 230 may be guided by a plurality of first balls 221 and a plurality of second balls 223.

The plurality of first balls 221 may be disposed in a respectively contacted state in-between a first corner part 210a of the inner side of the base 210 and a first guide surface 230a of the support 230 corresponding thereto.

The plurality of second balls 223 may be disposed in a diagonal direction based on the plurality of first balls 221. In this case, the plurality of second balls 223 may be disposed in a respectively contacted state in-between a second corner part 210b of the inner side of the base 210 and a second guide surface 230b of the support corresponding thereto.

The driving part for the first OIS may include a first coil 225 which is disposed at one side surface from among four side surfaces of the base 210, and a first magnet 255 which is disposed at one side surface from among four side surfaces of the lens module 250.

The driving part for second OIS may include a second coil 227 which is disposed at a side surface adjacent to the surface on which the first coil 225 is disposed from among the four side surfaces of the base 210, and a second magnet 257 which is disposed at a side surface adjacent to the surface on which the first magnet 255 is disposed from among the four side surfaces of the lens module 250.

In the base 210, two printed circuit boards 211 and 213 may be disposed at opposite sides from each other. One printed circuit board 211 may have a plurality of first terminals 211a, and the other printed circuit board 213 may have a plurality of second terminals 213a. Based on the size of the lens assembly 200 being manufactured to an ultra-small type, soldering work may be conveniently performed if the plurality of first terminals 211a and the plurality of second terminals 213a are positioned at opposite sides to each other.

While the disclosure has been shown and described with reference to the exemplary embodiments thereof, the disclosure is not limited to the embodiments specifically described and various modifications may be made therein by those skilled in the art to which this disclosure pertains without departing from the spirit and scope of the disclosure, and such modifications shall not be understood as separate from the technical concept or outlook of the present disclosure.

### INDUSTRIAL APPLICABILITY

The disclosure relates to an ultra-small lens assembly having an auto focus function and an optical image stabilization (OIS) function.

What is claimed is:

1. A lens assembly, comprising:
a base;
a lens module disposed at an inner side of the base;
driving parts for a first optical image stabilization (OIS) and a second OIS configured to move the lens module in a perpendicular direction of an optical axis direction; and
a plurality of hinge members configured to support the lens module to be movable and disposed parallel to one another,
wherein the plurality of hinge members is characterized in that a column part is gradually protruded to be convex as it nears a center and is injected molded with a synthetic resin.

2. The lens assembly of claim 1, further comprising:
a support inserted in the base to be movable in the optical axis direction; and
a driving part for adjusting auto focus which moves the support in the optical axis direction,
wherein each of the plurality of hinge members is characterized in that one end part is fixed to four corners of the support, and other end part is fixed to the lens module.

3. The lens assembly of claim 2, characterized in that,
an adhesive is applied to a portion through which the one end part of the plurality of hinge members and the support are connected to one another, and an adhesive is applied to a portion through which the other end part of the plurality of hinge members and the lens module are engaged to one another.

4. The lens assembly of claim 2, characterized in that,
each of the plurality of hinge members is configured such that a first connection part is formed in-between the one end part and the column part, and a second connection part is formed in-between the other end part and the column part, and
each of the first and second connection parts is formed to a thickness thinner than a thickness of the column part.

5. The lens assembly of claim 2, characterized in that the driving part for adjusting auto focus is a piezo actuator,
wherein the piezo actuator comprises:
a piezoelectric device fixed to the base; and
an expandable bar configured such that one end is connected to one side of the piezoelectric device and is connected to the support.

6. The lens assembly of claim 5, characterized in that,
the support further comprises a guide bar guiding a movement of the support in the optical axis direction by being connected to a corner which faces the corner at which the expandable bar is connected in a diagonal direction to be slidable.

7. The lens assembly of claim 1, characterized in that,
each of the plurality of hinge members is configured such that one end part is fixed to four corners of the base, and other end part is fixed to the lens module.

8. The lens assembly of claim 7, characterized in that,
an adhesive is applied to a portion through which the one end part of the plurality of hinge members and the base are connected to one another, and an adhesive is applied to a portion through which the one end part of the plurality of hinge members and the lens module are engaged with one another.

9. The lens assembly of claim 7, further comprising:
a movable member which moves an image sensor disposed at a rear direction of the lens module in the optical axis direction; and
a driving part for adjusting auto focus for the movable member to move in the optical axis direction.

10. The lens assembly of claim 9, characterized in that,
the movable member comprises:
a first portion to which the image sensor is engaged; and
a second portion extended from the first portion and disposed in-between a side wall of the base and the lens module.

11. The lens assembly of claim 10, characterized in that,
the image sensor is mounted to one portion of a flexible printed circuit board (FPCB), and
other portion of the FPCB is disposed in a folded state based on the one portion of the FPCB.

12. The lens assembly of claim 10, characterized in that,
the driving part for adjusting auto focus comprises:
a magnet disposed at the second portion; and
a coil disposed at a side wall of the base so as to face the magnet.
